(19) United States
(12) Patent Application Publication
(10) Pub. No.: US 2023/0000012 A1
(43) Pub. Date: Jan. 5, 2023

(54) CUTTING ELEMENT, USE THEREOF AND MOBILE CUTTING DEVICE THEREWITH

(71) Applicant: CERATIZIT Luxembourg S.a.r.l., Mamer (LU)

(72) Inventors: Michael Magin, Mamer (LU); Gregory Pierce, Mamer (LU); Romain Steckler, Mamer (LU)

(21) Appl. No.: 17/779,667

(22) PCT Filed: Nov. 19, 2020
(86) PCT No.: PCT/EP2020/082645

§ 371 Date: May 25, 2022

(30) Foreign Application Priority Data
Nov. 25, 2019 (EP) 19211203.5

(51) Int. Cl. A01D 34/73; B26F 1/44

(52) U.S. Cl. CPC A01D 34/73; B26F 1/44; B26F 2001/4436

(57) ABSTRACT

A cutting element is configured such that it may be used to cut grass stalks or other organic stalk materials in a vegetation area. The cutting element has a main body formed from a main body material and cutting bodies formed on opposite sides of the main body which have a longer service life in the region of the cutting body relative to the prior art. At least one of the cutting bodies is formed by a cutting body material which is distinct from the main body material, is sintered and is harder than the main body material. The sintered cutting body material is formed by a hard metal or cermet and the higher hardness thereof is based on hard material particles present therein.

The present invention relates to a cutting element configured such that it may be used to cut grass stalks or other organic stalk materials in a vegetation area comprising a main body formed by a main body material and cutting bodies formed on opposite sides of the main body.

The present invention further relates to a use of a cutting element for cutting grass stalks or other organic stalk materials in a vegetation area.

Finally, the invention relates to a mobile cutting apparatus, in particular a combine harvester or a robotic mower, comprising a rotor and at least one cutting element attached thereto in order that rotation of the rotor allows grass stalks or other organic stalk materials in a vegetation area to be cut by the cutting element.

A cutting element of the abovementioned type is already known from EP 3 273 766 A1 for example in the form of a lawnmower blade, i.e. as a cutting element for cutting of grass stalks. These may be cut by such a cutting element, i.e. the corresponding plant fibers are cut and accordingly separated from the vegetation area, in this case a lawn area. This is different from the machining of metals or the like, where in the manner of a plow and thus of a correspondingly shaped other cutting element, a metal is penetrated to produce a shaving. The corresponding cutting body of the cutting elements suitable therefor is therefore rather blunt and typically optimized for removing a shaving. However, when cutting grass stalks and other organic stalk materials it is, by contrast, the sharpness of the cutting body that is important to achieve a clean cut.

In the prior art lawnmower blade an overload protection is realized via a slit, in which a pin of a rotor engages eccentrically. In the case of an impact with a stone the lawnmower blade may accordingly pivot around the pin and slide along said pin. After a rotation realized in this way another of its cutting bodies is active for cutting without any need to alter the rotational direction of the rotor propelling the lawnmower blade.

The risk of fracture is reduced accordingly. However, this does not change the fact that the cutting bodies of the prior art lawnmower blades are subject to the customary wear during cutting of the grass stalks and other organic stalk materials.

It is therefore an object of the present invention to provide a cutting element of the abovementioned type, a use of the abovementioned type and a mobile cutting apparatus, in particular combine harvester or robotic mower, of the abovementioned type, in each case with a longer service life of the cutting body or cutting bodies relative to the prior art.

The object is achieved by a cutting element according to claim 1. Advantageous developments thereof are specified in the claims dependent on claim 1.

The cutting element configured such that it may be used to cut grass stalks or other organic stalk materials in a vegetation area comprises a main body formed by a main body material and cutting bodies formed on opposite sides of the main body, wherein at least one of the cutting bodies is formed by a cutting body material which is distinct from the main body material, is sintered and is harder than the main body material, wherein the sintered cutting body material is formed by a hardmetal or cermet and the higher hardness thereof is based on hard material particles present therein.

This is advantageous because such a cutting element is hard where reduction of wear is important, i.e. in the region of one of the cutting bodies, and is softer where an appropriate compliance of the cutting element is important for fracture avoidance, i.e. in the region of the main body. The latter measure provides damping of collision energy.

Hardmetal (cemented carbide) and cermet are both composite materials in which the hard material particles, which make up the predominant constituent of the composite material, form a skeleton or framework structure, whose interspaces are filled by a metallic binder that is more ductile in comparison. The hard material particles be especially be at least predominantly formed by tungsten carbide, titanium carbide and/or titanium carbonitride, wherein smaller amounts of, for example, other hard material particles, in particular carbides of elements of groups IV to VI of the periodic table, may also be present. The ductile metallic binder typically consists at least predominantly of cobalt, nickel, iron or an alloy based on at least one of these elements. However, smaller amounts of yet further elements may also be dissolved in the metallic binder. An alloy based on an element is to be understood as meaning that this element forms the predominant constituent of the alloy. The most frequently employed hardmetals are those in which the hard material particles are at least predominantly formed by tungsten carbide and the metallic binder is a cobalt- or cobalt-nickel-based alloy; the weight fraction of the corresponding tungsten carbide particles is especially at least 70% by weight, preferably more than 80% by weight.

In the context of the present disclosure skeleton structure is to be understood as meaning that the hard material particles, for example hard material particles formed substantially by tungsten carbide, form a cohesive particle network where any hard material particles is in contact with at least one other hard material particle.

It is particularly advantageous when at least two of the cutting bodies are made of the sintered cutting body material because this still further reduces the wear, for example in a reversal of the cutting direction of the cutting element. The latter is possible because the sintered cutting bodies are formed on the opposite sides. It is yet more preferable when the cutting bodies on all of the opposite sides of the main body are made of the sintered cutting body material, i.e. the hardmetal or cermet.

The main body is advantageously plate-shaped and has a greater area relative to the cutting bodies in a plate plane of the main body because this still further reduces the fracture risk of the sintered cutting body, i.e. the hardmetal or cermet. This is because in the cutting playing the main body provides sufficient damping of the sintered cutting body made of the hardmetal or cermet when said body impacts a hard object, for example a stone.

In the context of the present disclosure the terms “opposite sides” to be understood as meaning in particular the sides of the main body which lie parallel or diagonally opposite one another, for instance the corresponding sides of a square, rectangle, triangle, trapezium or parallelogram and also the sides of shapes which substantially correspond to the recited shapes.

The term hardness is to be understood as meaning the resistance against penetration of a harder test specimen into the cutting body material and the main body material.

Since the at least one cutting body is sintered it may advantageously be shaped independently of the main body because the corresponding green body may be shaped prior to the sintering, with the result that, in addition to the reduction in wear, the cutting performance is improved by adaptation of the geometry of the cutting body. This is in contrast to applying the cutting body using a deposition process, according to which the cutting body inherits the shape of the main body in the region of the side at which it is to be formed.

Since the cutting bodies are formed on the opposite sides of the main body, the sintered cutting body made of the hardmetal or cermet is active for cutting in a cutting motion of the cutting element, another of the cutting bodies which is optionally formed by the sintered cutting body material is passive for cutting, wherein in the case of reversal of the cutting motion the sintered cutting body made of the hard metal or cermet is passive for cutting and the other cutting body is active for cutting. According to the present disclosure the cutting element can cut the grass stalks or the other organic stalk material in two different cutting directions, for example clockwise and anticlockwise. Since the cutting bodies are formed on the opposite sides, the sintered cutting body made of the hardmetal or cermet is active for cutting in the cutting motion and another of the cutting bodies which is optionally formed by the sintered cutting body material is passive for cutting, wherein in the case of a change in the installation position of the cutting element while retaining the cutting motion the sintered cutting body made of the hard metal or cermet is passive for cutting and the other cutting body is active for cutting. The installation position may be realized by a rotation of the main body where an original underside thereof is turned upwards and an original top side is turned downwards, i.e. the main body is flipped, namely around a rotational axis which is in the sectional plane. Alternatively or in addition, the installation position may be realized by a centric or eccentric rotation of the main body with respect to a center of mass of the main body, i.e. by a rotation around an axis perpendicular to the sectional plane. In the latter case the main body is set into a longitudinal motion by the rotation, for instance in the manner of an eccentric, so that the two installation positions are symmetrical relative to one another, such is also possible in centric rotation without longitudinal motion of the main body.

The other organic stalk materials are in particular to be understood as meaning other sweet grasses, for example cereals, especially wheat, rye, barley, oats and corn, but also sugar cane and reeds and the like.

In a development of the cutting element the hard material particles of the hardmetal are substantially formed by tungsten carbide. This is advantageously a particularly hard material which still further reduces wear and thus increases service life. The weight fraction of corresponding tungsten carbide particles, which may also be referred to as tungsten carbide grains, based on the total composition of the sintered cutting body material made of the hardmetal, is preferably in the range from 70% by weight to 99% by weight inclusive, yet more preferably from 80% by weight to 99% by weight inclusive, most preferably from 85% by weight to 99% by weight inclusive; a range from 88% by weight to 99% by weight also being conceivable and possible. However, other additional hard material particles formed by carbides or carbonitrides of metals of groups IV to VI of the periodic table are also conceivable and possible.

In a development of the cutting element a binder in interspaces between the hard material particles of the hardmetal or cermet is formed by cobalt, nickel and/or iron or an alloy based on one of these elements. An alloy based on a metal is to be understood as meaning that this metal forms the main constituent of the alloy. In addition to the recited elements, further elements may also be dissolved in the binder in small amounts.

In a development of the cutting element the sintered cutting body made of the hardmetal or cermet is joined to the main body by an atomic-level join. This is advantageous because the sintered cutting body made of the hardmetal or cermet may be replaced by another cutting body of analogous construction if such replacement were required despite the elevated wear resistance.

An atomic-level join is to be understood as meaning for example that the sintered cutting body made of the hard metal or cermet is soldered, adhesive-bonded or welded to the side of the main body.

In a development of the cutting element the sintered cutting body made of the hardmetal or cermet is joined to the main body by an atomic-level join where at least the main body material has been melted by the action of an energy beam. This provides a particularly stable join of the cutting body to the main body. The energy beam may be a laser beam or an electron beam for example.

In a development of the cutting element the sintered cutting body made of the hardmetal or cermet has a wedge angle of not more than 60° and more than 0°, preferably not more than 45° and not less than 15°. As a result the sintered cutting body made of the hardmetal or cermet has a particularly sharp cut; the individual values of these ranges are also disclosed here, i.e. all wedge angles from more than 0° to 60° inclusive. The resulting cutting edge of the sintered cutting body made of the hardmetal or cermet may be symmetrical, i.e. an equilateral or isosceles triangle in cross section, or asymmetric, i.e. in the shape of a right-angled triangle in cross section for example. Symmetrical cutting edges provide a particularly stable cut, while asymmetric cutting edges provide a particularly sharp cut.

In a development of the cutting element the hard material particles have an average grain size of 0.5 μm to 2 μm, preferably 0.8 μm to 1.3 μm. This is advantageous especially for cutting the grass stalks or other organic stalk materials in the vegetation area since the grain size range of 0.5 μm to 2 μm, preferably 0.8 μm to 1.3 μm, makes the cutting body material harder and more resistant and increases breaking stress. The cutting body material can thus be produced with a sharper cut, i.e. To cut the grass stocks more precisely, and retain a sharp cut for longer. This is yet further improved when the hard material particles of the hardmetal are substantially formed by tungsten carbide. The weight fraction of the tungsten carbide particles may especially be in the range from 70% by weight to 99% by weight inclusive, yet more preferably from 80% by weight to 99% by weight inclusive, most preferably from 85% by weight to 99% by weight inclusive; a range from 88% by weight to 99% by weight also being conceivable and possible.

In the context of the present disclosure substantially formed by tungsten carbide is to be understood as meaning that at least 90% of the hard material particles are formed by tungsten carbide, preferably 95%, most preferably 99%. The same applies in cases where the hard material particles are substantially formed by another hard material phase.

In the present disclosure grain size is measured as “linear intercept length” according to international standard ISO 4499-2:2008(E). EBSD micrographs (EBSD, electron back-scatter diffraction) were used as a basis. The measurement methodology for such micrographs is described, for example, in: K. P. Mingard et al., Comparison of EBSD and conventional methods of grain size measurement of hard metals”, Int. Journal of Refractory Metals & Hard Materials 27 (2009) 213-223.

In a development of the cutting element the sintered cutting body made of the hardmetal or cermet is in the form of a single piece cutter bar which extends substantially along the entire side of the main body at which it is formed. This is a particularly useful measure that increases cutting performance. It is preferable when at least the cutting body opposite the cutter bar formed in such a way is likewise formed from the sintered cutting body material, i.e. the hardmetal or cermet, and shaped as such a cutter bar.

In a development of the cutting element at least one of the sides of the main body is substantially straight, concave from an external point of reference or forms a V-shape with the opposite side of the main body, wherein the sintered cutting body is formed from the hardmetal or cermet at the side having this shape. These are particularly advantageous shapes of the main body/the sintered cutting body made of the hardmetal or cermet. In the case of the concave side and the V-shape the mass of the cutting element can advantageously be reduced. This increases service life since the collision energy in a collision of the cutting element with a stone or the like is correspondingly reduced. However, two of the opposite sides of the main body may also be formed substantially parallel to one another, wherein the sintered cutting body is formed at one of these sides.

In this development of the cutting element in the case of the V-shape for example the main body is substantially triangular; if a recess provided in the main body in which a pin of a rotor can engage is substantially triangular, the edges of the recess are rounded and are symmetrically arranged around a center of mass of the main body.

In a development of the cutting element the main body material is formed by a steel. This is advantageous because steel has a particularly good combination of ductility, toughness and strength and thus reduces the fracture risk of the sintered cutting body material while maintaining sufficient dimensional stability of the cutting element, especially if the hard material particles thereof are formed by tungsten carbide and the binder is formed by cobalt, nickel and/or iron or an alloy based on one of the elements. In this case cobalt or an alloy based thereon is particularly advantageous.

In a further development of the cutting element the main body has at least one recess configured for securing the cutting element to a rotor. This allows the cutting element to be advantageously operated with a mobile cutting apparatus, for example a combine harvester, mobile robotic mower or a handheld other cutting apparatus, comprising the rotor. The recess may be formed by one or more drilled holes which penetrate the main body so that a pin of the rotor may be inserted through the cutting element, wherein the cutting element is especially freely rotatably engaged with the pin, namely eccentrically relative to the center of mass of the cutting element. The cutting element can thereby be aligned outwards by the centrifugal force brought about by a rotation of the rotor. If two or more of the recesses are provided, for example two, three, four or five, especially in the case of corresponding drilled holes, it is therefore advantageous when these are arranged eccentrically and at the same time symmetrically around a center of mass. If a recess is formed this may be formed by two or more drilled holes which intersect in a center of mass of the cutting element.

In a development of the cutting element the recess is formed between two of the opposite sides of the main body, wherein the sintered cutting body made of the hardmetal or cermet is formed at one of these sides. This advantageously allows the mass of the cutting element to be reduced since a separate region therefor, for example in the form of a projection of the main body, is avoided. This reduces the collision energy and thus increases the service life.

However it is also possible and conceivable in another development for this recess to be realized, as a result of which the recess or at least one of the recesses is formed outside the opposite sides at which the cutting bodies are formed. This has the advantage that the effective cutting length in the longitudinal direction of the cutting body/bodies is increased.

In a development of the cutting element the recess has at least two rounded regions, the rounded regions each form a pivot bearing for rotation of the cutting element around a pin of the rotor, the rounded regions are joined to one another by a distinctly formed connection side of the recess and the sintered cutting body made of the hardmetal or cermet is formed at the side of the main body which is opposite the connection side or one of the rounded regions. This has the result that on the one hand the cutting element can be particularly advantageously rotated about the pin in order to align said element via centrifugal force while simultaneously mounting it in a manner that is compliant with respect to a collision of the sintered cutting body made of the hardmetal or cermet with a hard object, which in the latter case increases service life. On the other hand the cutting element and thus the main body can slide on the pin from the one rounded region to the other rounded region along the distinctly formed side of the recess. As a result, a collision of the sintered cutting body made of the hardmetal or cermet with a stone during a rotation of the rotor causes a portion of the rotational motion of the cutting body to be translated into a translational motion, for instance in the manner of an eccentric. After a whole rotation around the pin the sintered cutting body made of the hardmetal or the cermet is passive for cutting and a cutting body opposite, which may likewise be formed by the sintered cutting body material, is active for cutting or vice versa. It is particularly advantageous when the recess thus formed is symmetrically formed around the center of mass of the cutting element, for instance symmetrically in the manner of a rotation of 180°, 90° or even higher rotational symmetry, i.e. the recess is covered by itself after a corresponding rotation; the axis of rotation penetrates the center of mass of the cutting element and is perpendicular to the cutting plane.

One or more of the rounded regions form the swivel bearing especially when said regions sectionally circumferentially surround the pin in planar fashion.

In the context of the present disclosure a pin is formed for example by a cylindrical element, a rotor for example by a disc-shaped body where the pin is joined thereto eccentrically and an intended rotational axis centrically penetrates this body perpendicular to a disc plane. When the pin is cylindrical the rounded region(s) is/are preferably formed to follow such a shape when viewed from inside the recess.

In a development of the cutting element the connection side has a convex curvature from an external point of reference and one of the rounded regions is opposite the side of the main body at which the sintered cutting body made of the hardmetal or cermet is formed. The pin can therefore slide along the convex connection side. This is particularly advantageous when the main body is substantially triangular, three of the rounded areas are provided and accordingly these are connected by altogether three of the convex connecting sides, the recess therefore having the shape of a triangle having rounded corners and convex sides when viewed from inside. This allows altogether three of the cutting bodies to be formed at the opposite side of the main body, of which at least one of the sintered cutting bodies is made of the hardmetal or cermet, and in case of collision these switch from a position active for cutting to a position passive for cutting for protection, because the recess is configured for a corresponding rotational and longitudinal motion. It is particularly advantageous when the recess shaped in this way is symmetrical about the center of mass of the cutting element.

In a development of the cutting element the connection side is substantially straight and is opposite the side of the main body at which the sintered cutting body made of the hardmetal or cermet is formed. The pin can therefore slide along the straight connection side. This is particularly advantageous when the main body is substantially rectangular or square, two of the rounded areas are provided and accordingly these are connected by altogether two of the straight connecting sides, the recess therefore having the shape of a rectangle or square having rounded corners and straight edges. In the case of the rectangle the recess is accordingly elongate, for instance in the manner of a longitudinal drilled hole having rounded edges. In both cases the straight connection sides preferably run substantially parallel to the side of the main body at which the sintered cutting body made of the hardmetal or cermet is formed. In both cases altogether two of the cutting bodies can be formed at two of the opposite side of the main body, of which at least one of the sintered cutting bodies is made of the hardmetal or cermet, and in case of collision these switch from a position active for cutting to a position passive for cutting for protection, because the recess is configured for a corresponding rotational and longitudinal motion. It is particularly advantageous when the recess shaped in this way is symmetrical about the center of mass of the cutting element.

This development is yet further improved when two of the opposite sides of the main body are formed substantially parallel to one another, the sintered main body made of the hardmetal or cermet is formed at one of the sides and the recess is the elongate such that its long sides extend substantially parallel to the substantially parallel sides of the main body.

The object is also achieved by the use as claimed in claim 14, i.e. the use of at least one cutting element as claimed in claim 1 or a claim dependent thereon or the presently disclosed developments or embodiments of the cutting element for cutting of grass stalks or other organic stalk materials in a vegetation area. The cutting element is therefore used for cutting these materials, wherein the sintered cutting body made of the hardmetal or cermet is preferably active for cutting or becomes active for cutting by alteration of the installation position by rotation about a rotational axis perpendicular or parallel to the cutting plane. In case of use for cutting of grass stalks this may also be referred to as lawnmowing. The cutting element is yet more preferably used together with a rotor of a mobile cutting apparatus to which it is secured in a wing-like manner, in particular to a pin thereof, most preferably eccentrically secured to the pin, for example so as to be freely rotatable and alignable by centrifugal force.

The object is also achieved by the mobile cutting apparatus, in particular a combine harvester or robotic mower, as claimed in claim 15.

The mobile cutting apparatus, in particular the robotic mower, comprises a rotor and at least one cutting element as claimed in claim 1 or a claim dependent thereon or the presently disclosed developments or embodiments attached thereto such that a rotation of the rotor makes it possible to cut grass stalks or other organic stalk materials in a vegetation area. The mobile cutting apparatus may be for example a mowing machine, for example a combine harvester, a robotic mower such as for example a self-driving robot having a chassis, a drivetrain therefor, the rotor and a drive therefor, which is particularly preferably configured for lawnmowing. In the case of a robotic mower the cutting element is secured to the rotor in a wing-like manner, in particular to a pin thereof, most preferably eccentrically secured to the pin, for example so as to be freely rotatable and alignable by centrifugal force. It is conceivable and possible for the mobile cutting apparatus to be directly hand-guidable, for example in the form of lawn shears.

Further advantages and expediencies of the invention result are apparent from the following description of exemplary embodiments with reference to the accompanying figures.

In the figures:

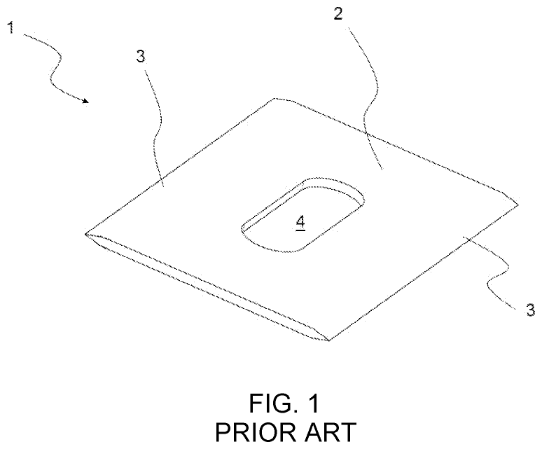

FIG. 1: shows a perspective schematic representation of a cutting element having a rectangular main body, cutting bodies formed at two opposite sides thereof and an elongate recess according to the prior art;

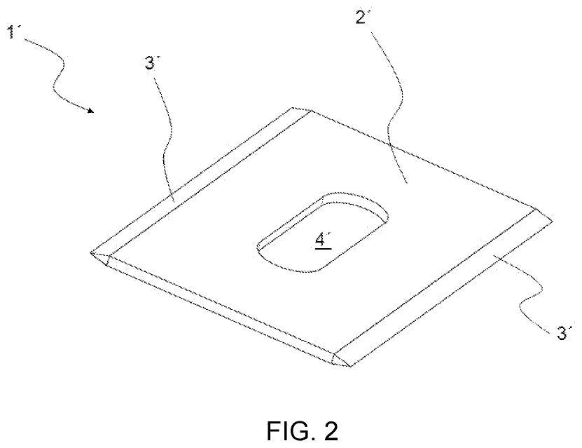

FIG. 2: shows a perspective schematic representation of a cutting element having a rectangular main body made of a steel, cutting bodies made of a sintered hardmetal formed at two opposite sides thereof and an elongate recess according to a first embodiment;

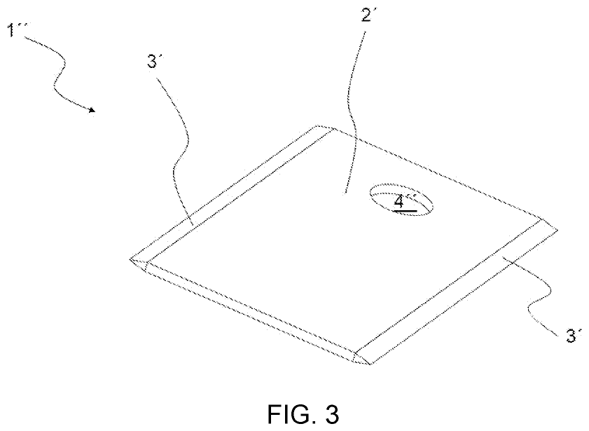

FIG. 3: shows a perspective schematic representation of a cutting element having a rectangular main body made of a steel, cutting bodies made of a sintered hardmetal at two opposite sides thereof and a round recess according to a second embodiment;

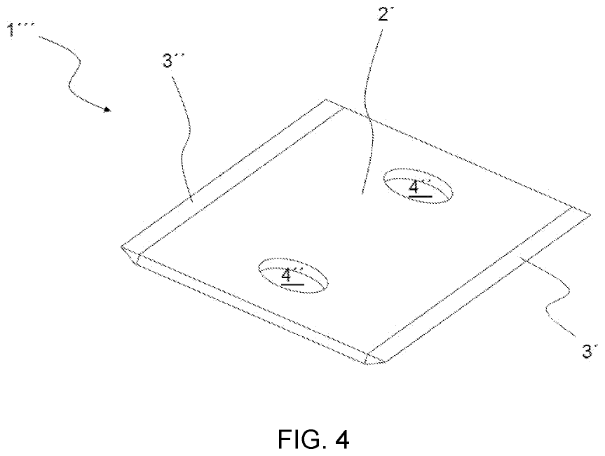

FIG. 4: shows a perspective schematic representation of a cutting element having a rectangular main body made of a steel, cutting bodies made of a sintered hardmetal formed at two opposite sides thereof and two round recesses according to a third embodiment;

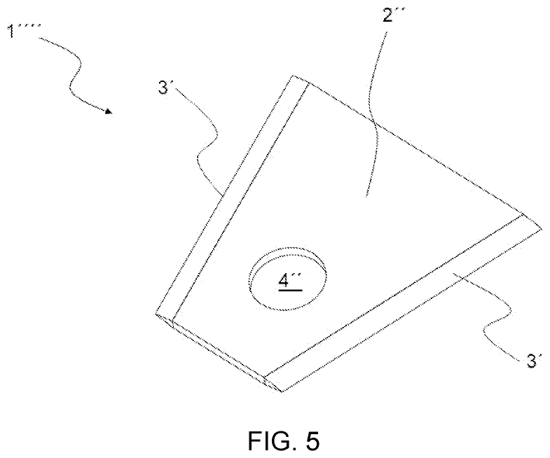

FIG. 5: shows a perspective schematic representation of a cutting element having a trapezoidal main body made of a steel, cutting bodies made of a sintered hardmetal formed at two opposite sides thereof and two round recesses according to a fourth embodiment;

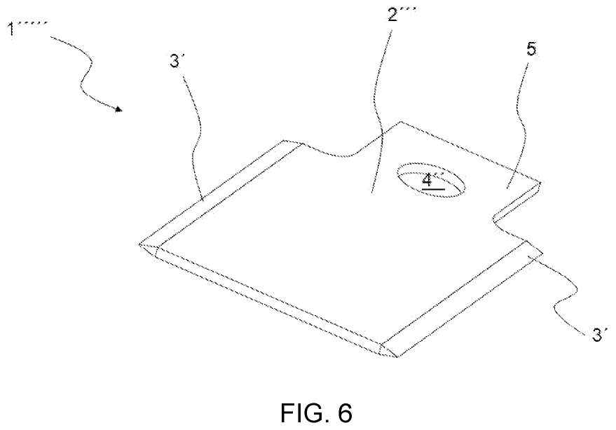

FIG. 6: shows a perspective schematic representation of a cutting element having a rectangular main body made of a steel, cutting bodies made of a sintered hardmetal formed at two opposite sides thereof, a plate-shaped extension of the main body and a round recess therein according to a fifth embodiment;

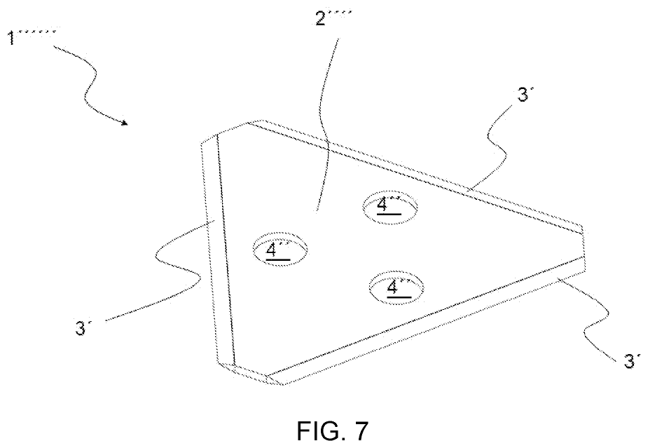

FIG. 7: shows a perspective schematic representation of a cutting element having a triangular main body made of a steel, cutting bodies made of a sintered hardmetal formed at three opposite sides thereof and three recesses according to a sixth embodiment; and

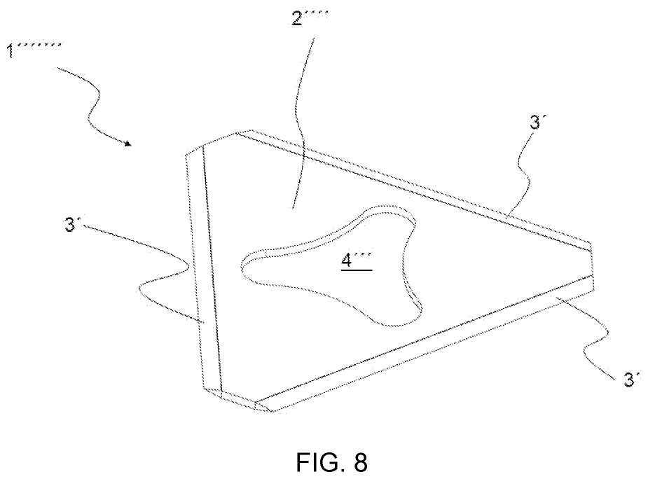

FIG. 8: shows a perspective schematic representation of a cutting element having a triangular main body made of a steel, cutting bodies made of a sintered hardmetal formed at three opposite sides thereof and a recess in the shape of a triangle having rounded corners and sides that are convex when viewed from inside according to a seventh embodiment.

In FIGS. 1 to 8, elements that are the same, similar or have the same effect are denoted by identical reference numerals and repeated description of these elements is avoided in the following description to avoid redundancies.

FIG. 1 shows a representation of a cutting element 1 according to the prior art. The cutting element 1 has a plate-shaped rectangular main body 2. Two of the opposite long sides of the main body 2 each symmetrically narrow outwards in a wedge shape. This accordingly forms two opposite cutting bodies 3 by which grass stalks or else other organic stalk materials such as cereals, sugar cane or reeds can be cut. To this end an elongate recess 4 of the main body 2 is brought into engagement with a pin (not show) of a rotor (not shown) of a cutting apparatus (not shown), for example a robotic mower When the rotor is rotated sufficiently fast the cutting element 1 aligns itself radially outwards relative to a rotational axis of the rotor; the rotational axis is perpendicular to the plate plane of the main body 2. The pin is disposed in one of the rounded regions of the recess 4, each of which is formed by two rounded corners of the recess and forms a pivot bearing for rotating the cutting element 1 at and around the pin. The cutting element 1 is thus eccentrically mounted on the pin since the center of mass of the cutting element 1 is in the center of the recess 4, said recess therefore being formed symmetrically around the center of mass of the cutting element 1. If one of the two cutting bodies 3 collides with a stone during cutting of the grass stalks, the cutting element 1 is rotated around the pin and at the same time slides along the long sides of the recess 4, in the case of a thin pin on only one of these sides, towards the other rounded region of the recess 4. The cutting body 3 that collided with the stone is then positioned on the other side, i.e. passive for cutting, relative to the view selected in FIG. 1, while the other cutting body 3, which had faced away from the stone, now takes the position of the cutting body 3 that collided with the stone, i.e. is active for cutting.

It is particularly readily visible in FIG. 1 that the cutting bodies 3 are monolithically joined to the main body 2 without a material seam, i.e. are formed from the main body 2. The cutting body 3 and the main body 2 and therefore made of the same material.

FIG. 2 shows a representation of a cutting element 1′ according to a first embodiment. Similarly to the cutting element 1, the cutting element 1′ has a plate-shaped rectangular main body 2′. A wedge-shaped cutting body 3′ is secured to each of the opposite long sides of the main body 2′ by the action of an energy beam. However, it is also conceivable and also possible for the cutting bodies 3′ to be joined to the main body 2′ by soldering. In contrast to the cutting bodies 3 the cutting bodies 3′ are made of a sintered hardmetal and are accordingly hard and wear-resistant and are subsequently, i.e. after the sintering, joined to the main body 2′; the hard material particles are formed by tungsten carbide and the binder by cobalt. By contrast, the main body 2′ is made of steel, is therefore softer compared to the cutting bodies 3′ and therefore damps collision energy introduced into the cutting bodies 3′ by dissipation therein. The operating principle of the elongate recess 4′ formed in the main body 2′, whose long sides are arranged parallel to the sintered cutting bodies 3′ or the corresponding sides of the main body 2′ and whose rounded regions are connected to one another and act as a pivot bearing for the pin, is the same as that of the recess 4 from the prior art.

In FIG. 2 it is apparent that the cutting bodies 3′ each symmetrically narrow outwards in a wedge shape and thus form corresponding symmetrical cutting edges. The wedge angle of these is in each case less than 45°.

FIG. 3 shows a representation of a cutting element 1″ according to a second embodiment. The cutting element 1″ differs from the cutting element 1″ only in that a recess 4″ in the main body 2″ differs from the recess 4″. The recess 4″ is round, as obtainable by a single drilled hole perpendicular to the plate plane of the main body 2″. Similarly to the recess 4″, where this comprises the two rounded regions, the recess 4″ serves as a pivot bearing in which the pin engages. Upon collision of one of the sintered cutting bodies 3″ with the stone the cutting element 1″ is rotated about the pin, as a result of which after a full revolution (360°) the collided sintered cutting body 3″ remains active for cutting. A change from the cutting body 3″ active for cutting to the cutting body 3″ previously passive for cutting on account of facing away from the stalk material can be realized by detaching the cutting element 1″ from the pin and then rotating it by 180° about a rotational axis oriented parallel to one of the long sides of the main body 2 and finally joining it to the pin so as to be freely rotatable in this position.

FIG. 4 shows a representation of a cutting element 1′″ according to a third embodiment. The cutting element 1′″ differs from the cutting element 1″ only in that two of the round recesses 4″ are formed in the main body 2′, namely diametrically to one another and equidistant to the center of mass of the cutting element 1′″, and in that sintered cutting bodies 3″ analogous to the sintered cutting bodies 3′ each asymmetrically narrow outwards in a wedge shape and thus form correspondingly asymmetric cutting edges. The wedge angle of these is in each case less than 45°.

The cutting element 1′″ can realize a change from a cutting body active for cutting 3″ to another cutting body 3″ previously passive for cutting similarly to the cutting element 1″, wherein the pin is engaged with the same recess 4″ before and after the change. Alternatively, the change can also be realized by detaching the cutting element 1′″ from the pin, rotating it by 180° about a rotational axis oriented perpendicular to the plate plane of the main body 2′ and thus inserting the pin into the other of the recesses 4″. The sintered cutting bodies 3″, which are made of the material of the cutting body 3′ and like these are joined to the main body 2′ by an atomic-level join, on account of their asymmetric shape each terminate flush with the main body 2′ at the side thereof shown in FIG. 4 so that the cutting element 1′″ can lie flat on the rotor even in the region of the sintered cutting bodies 3″.

FIG. 5 shows a representation of a cutting element 1″″ according to a fourth embodiment. The cutting element 1″″ has a trapezoidal main body 2″ which, like the main body 2′, is made of steel. On the sloping sides thereof, the sintered cutting bodies 3′ are joined to the main body 2″ by an atomic-level join similarly to the other embodiments. The sloping sides form a V-shape. The round recess 4″ is formed outside the center of mass of the cutting element 1″″, so that for the cutting element 1″″ too a centrifugal force-mediated alignment thereof radially outwards is effected upon rotation of the rotor. The change from the sintered cutting body 3′ active for cutting to a sintered cutting body 3′ which was previously passive for cutting and subsequently becomes active for cutting is realized similarly to cutting element 1″.

FIG. 6 shows a representation of a cutting element 1′″″ according to a fifth embodiment. In a departure from the cutting element 1″ this comprises a rectangular plate-shaped main body 2′″ having a plate-shaped narrower extension 5 thereof which is disposed outside the sides of the main body 2′″ at which the sintered cutting bodies 3′ are joined thereto by an atomic-level join; the main body 2′″ is made of the steel of the other embodiments. The change from a sintered cutting body 3′ active for cutting to a sintered cutting body 3′ which was previously passive for cutting and subsequently becomes active for cutting is realized similarly to the cutting element 1″. The round recess 4″ is formed outside the center of mass of the cutting element 1′″″, so that for the cutting element 1′″″ too a centrifugal force-mediated alignment thereof radially outwards is effected upon rotation of the rotor.

FIG. 7 shows a representation of a cutting element 1″″″ according to a sixth embodiment. A plate-shaped main body 2″″ of the cutting element 1″″″ is configured in the shape of a triangle with straight-cut corners. On the three main sides of the main body 2″″, pairs of which form a V-shape, altogether three of the sintered cutting bodies 3′ are joined to the main body 2″″ by an atomic-level join as in the other embodiments. Three of the round recesses 4″ are arranged symmetrically around the center of mass of the cutting element 1″″″. The change from a sintered cutting body 3′ which is active for cutting to a sintered cutting body 3′ which was previously passive for cutting and subsequently becomes active for cutting is realized by each recess 4″ as such similarly to cutting element 1″ and alternatively by changing from the recess 4″ that was originally engaged with the pin to another of the recesses 4″. Since each of the recesses is formed outside the center of mass of the cutting element 1′″″, the cutting element 1″″″ too experiences a centrifugal force-mediated alignment thereof radially outwards upon rotation of the rotor for each engagement in any of the recesses 4″.

FIG. 8 shows a representation of a cutting element 1′″″″ according to a seventh embodiment. The cutting element 1′″″″ differs from the cutting element 1″″″ only in that a recess 4′″ is formed in the main body 2″″ whose three corners are rounded and whose three sides have a convex curvature when viewed from inside from the recess 4″″. Each of the rounded corners acts as a pivot bearing for the pin similarly to recess 4″ and is arranged opposite one of the sintered cutting bodies 3′. In the case of a collision, where one of these cutting bodies 3′ collides with a stone, the pin can slide along one of the convex sides until it engages with another of the rounded corners there. In the case of such a sliding motion in combination with a rotation about the pin one of the cutting bodies 3′ which was previously passive for cutting becomes active for cutting and vice versa similarly to recess 4″.

It is conceivable and also possible that only one of the cutting bodies 3′ or 3″ is sintered and formed by the hardmetal in the cutting elements 1′, 1″, 1′″, 1″″, 1′″″, 1″″″ and 1′″″″ represented in the FIGS. 2 to 8.

1-15. (canceled)

16. A cutting element configured to cut grass stalks and other organic stalk materials in a vegetation area, the cutting element comprising:
a main body formed from a main body material; and
cutting bodies formed on opposite sides of said main body, at least one of said cutting bodies being formed from a cutting body material which is distinct from said main body material, is sintered and is harder than said main body material, wherein said cutting body material is formed by a hardmetal or cermet and a higher hardness thereof is based on hard material particles present in said cutting body material.

17. The cutting element according to claim 16, wherein said hard material particles of said hardmetal are formed from tungsten carbide.

18. The cutting element according to claim 16, further comprising a binder disposed in interspaces between said hard material particles of said hardmetal or said cermet and is formed from cobalt, nickel and/or iron or an alloy based on one of said cobalt, said nickel or said iron.

19. The cutting element according to claim 16, wherein said at least one cutting body made of said hardmetal or said cermet is joined to said main body by an atomic-level connection.

20. The cutting element according to claim 16, wherein said at least one body made of said hardmetal or said cermet is joined to said main body by an atomic-level connection where at least said main body material has been melted by an action of an energy beam.

21. The cutting element according to claim 16, wherein said at least one cutting body made of said hardmetal or said cermet has a wedge angle of not more than 60° and more than 0°.

22. The cutting element according to claim 16, wherein said hard material particles have an average grain size of 0.5 μm to 2 μm.

23. The cutting element according to claim 16, wherein:
at least one side of said main body is straight or forms a V-shape with an opposite side of said main body; and
said at least one cutting body formed from said hardmetal or said cermet at said side of said main body being straight or having said V-shape.

24. The cutting element according to claim 16, wherein said main body material is formed from steel.

25. The cutting element according to claim 16, wherein said main body has at least one recess formed therein and configured for securing the cutting element to a rotor.

26. The cutting element according to claim 25, wherein said recess has at least two rounded regions, said rounded regions each form a pivot bearing for rotation of the cutting element around a pin of the rotor, said rounded regions are joined to one another by a distinctly formed connection side of said recess and said at least one cutting body made of said hardmetal or said cermet is formed at a side of said main body which is opposite a connection side or one of said rounded regions.

27. The cutting element according to claim 26, wherein said connection side has a convex curvature from an external point of reference and in that one of said rounded regions is opposite said side of said main body at which said at least one cutting body made of said hardmetal or said cermet is formed.

28. The cutting element according to claim 26, wherein said connection side is straight and is opposite said side of said main body at which said at least one cutting body made of said hardmetal or said cermet is formed.

29. The cutting element according to claim 16, wherein said at least one cutting body made of said hardmetal or said cermet has a wedge angle of not more than 45° and not less than 15°.

30. The cutting element according to claim 16, wherein said hard material particles have an average grain size of 0.8 μm to 1.3 μm.

31. A method of cutting vegetation, which comprises the step of:
providing the cutting element according to claim 16; and
cutting grass stalks or other organic stalk materials in a vegetation area using the cutting element.

32. A mobile cutting apparatus, comprising:
a rotor;
at least one said cutting element according to claim 16, said at least one cutting element attached to said rotor in order that rotation of said rotor allows grass stalks or other organic stalk materials in a vegetation area to be cut by said at least one cutting element.

33. The mobile cutting apparatus according to claim 32, wherein the mobile cutting apparatus is a combine harvester or a robotic mower.
